(19) United States
(12) Patent Application Publication
(10) Pub. No.: US 2015/0292473 A1
(43) Pub. Date: Oct. 15, 2015

(54) FLOATING MARINE CURRENT TURBINE

(71) Applicant: TIDALYS, Cherbourg Octeville (FR)

(72) Inventor: Rémi Laval-Jeantet, Saint Brice sous Foret (FR)

(21) Appl. No.: 14/437,586

(22) PCT Filed: Oct. 22, 2013
(86) PCT No.: PCT/EP2013/072010

§ 371 Date: Apr. 22, 2015

(30) Foreign Application Priority Data
Oct. 24, 2012 (FR) 12/60106

(51) Int. Cl. F03B 13/26; F03B 13/10

(52) U.S. Cl. CPC F03B 13/264; F03B 13/10

(57) ABSTRACT

The invention concerns a floating tidal turbine comprising:
means of flotation,
a technical room resting on the means of flotation above the water and in which is disposed an electrical generator,
a mast immersed in water beneath the control room,
a propeller mounted rotationally on the base of the mast around a horizontal axis of rotation,
means of transfer that make it possible to transmit the rotational movement of the propeller to the electrical generator, and
a manoeuvring system that is designed to raise or lower the mast along a axis that is vertical relative to the technical room.

The present invention pertains to a floating tidal turbine.

There are numerous floating tidal turbines, but none of them is entirely satisfactory in terms of stability or maintenance.

One object of the present invention is to propose a floating tidal turbine that does not have the drawbacks of the prior art, in particular one that is stable and whose parts can be more easily maintained.

To that end, the invention discloses a floating tidal turbine comprising:
means of flotation,
a technical room resting on the means of flotation above the water and in which is disposed an electrical generator,
a mast immersed in water beneath the control room,
a propeller mounted rotationally on the base of the mast around a horizontal axis of rotation,
means of transfer that make it possible to transmit the rotational movement of the propeller to the electrical generator and
a manoeuvring system that is designed to raise or lower the mast along a axis that is vertical relative to the technical room.

Advantageously, the technical room features a floor and a ceiling and the floor and the ceiling each exhibit a hole that the mast passes through.

Advantageously, the means of flotation comprise:
at least two floats, and
a connective structure intended to connect the floats to one another and to support the technical room.

Advantageously, the connective structure comprises:
a first set of three beams, each one taking a roughly horizontal position and linking the floats two by two and on which said floor rests, and
a second set of four beams, each one being fastened between one of the floats and said ceiling.

Advantageously, the floating tidal turbine comprises at least one latch, the mast features, for the or each latch, an orifice passing through it and into which said latch fits, and when the mast is in the lowered position, said orifice is at the level of the floor.

Advantageously, the axis of rotation of the electrical generator is vertical.

Advantageously, the electrical generator is disposed just behind the trailing edge of the mast.

Advantageously, the manoeuvring system comprises a tank disposed inside the mast featuring, on its lower part, a first valve connecting the inside of said tank with the outside, and on its upper part, a second valve connecting the inside of said tank with the outside, each one able to be controlled independently to open and to close, a compressed air generator disposed in the technical room, and a conduit connecting the compressed air generator to the tank.

Advantageously, the propeller is a contra-rotating propeller that comprises two propellers placed one behind the other in the axis, and rotating in opposite directions.

Advantageously, the distance between the centres of the two propellers is less than 10% of the propellers' diameter.

The characteristics of the aforementioned invention, and others, will be revealed more clearly on reading the following description of an example of operation. This description is given in conjunction with the appended drawings, among which:

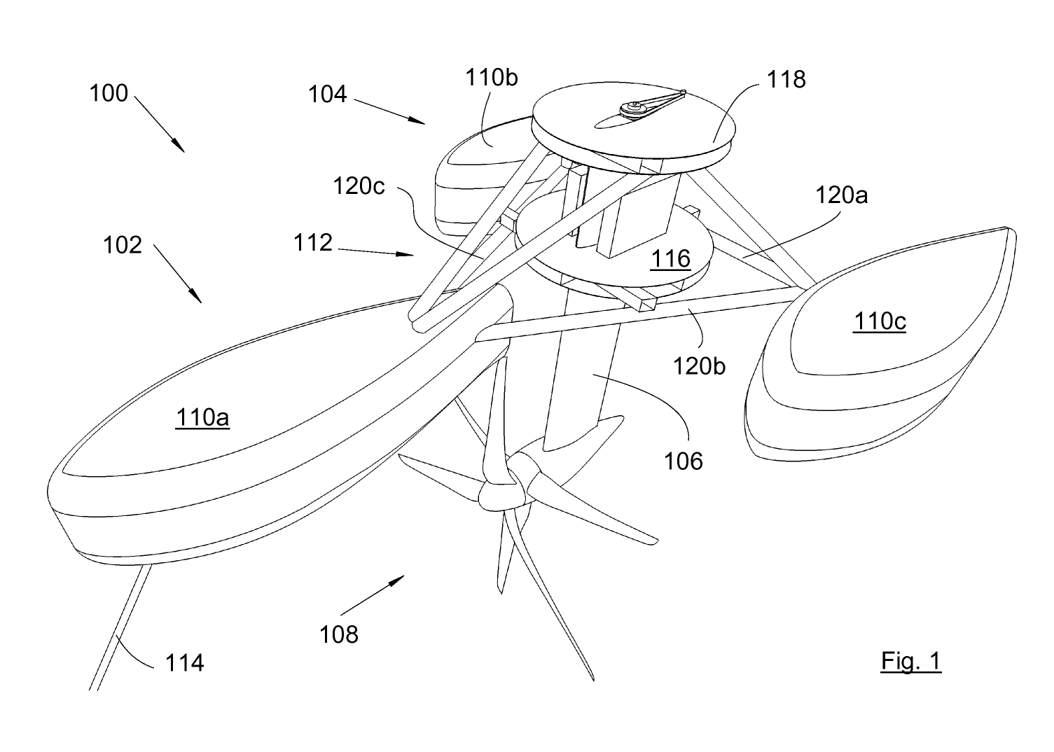

FIG. 1 shows a floating tidal turbine according to the invention,

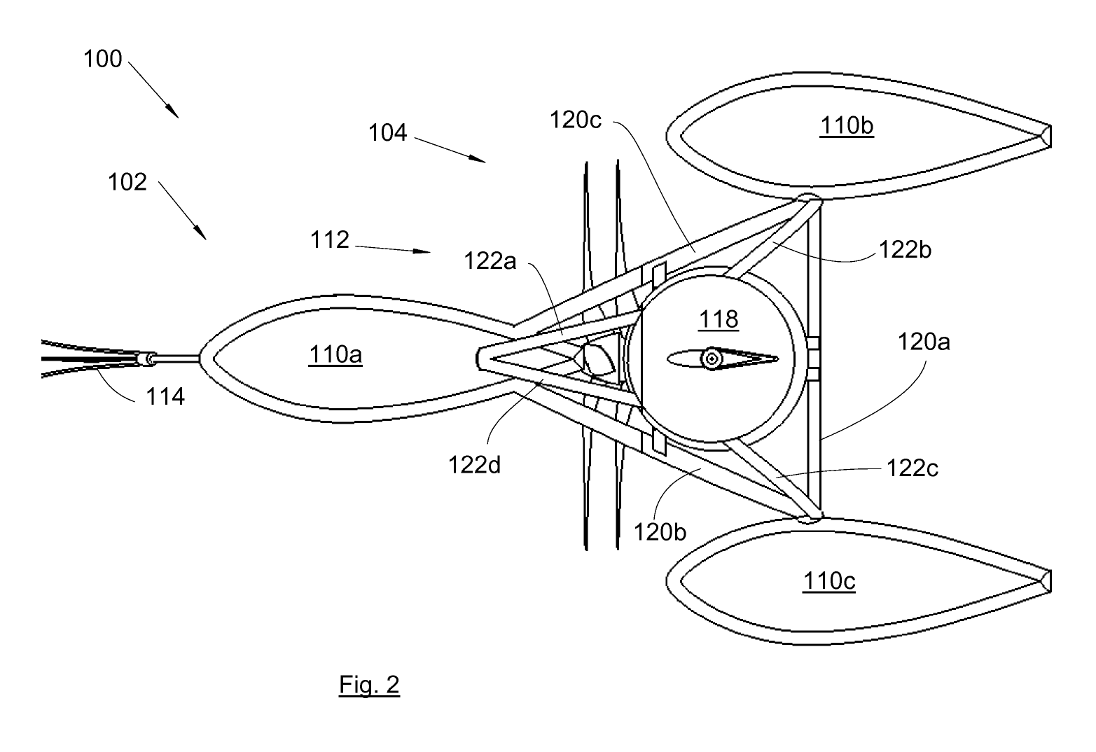

FIG. 2 shows a top view of the floating tidal turbine of FIG. 1,

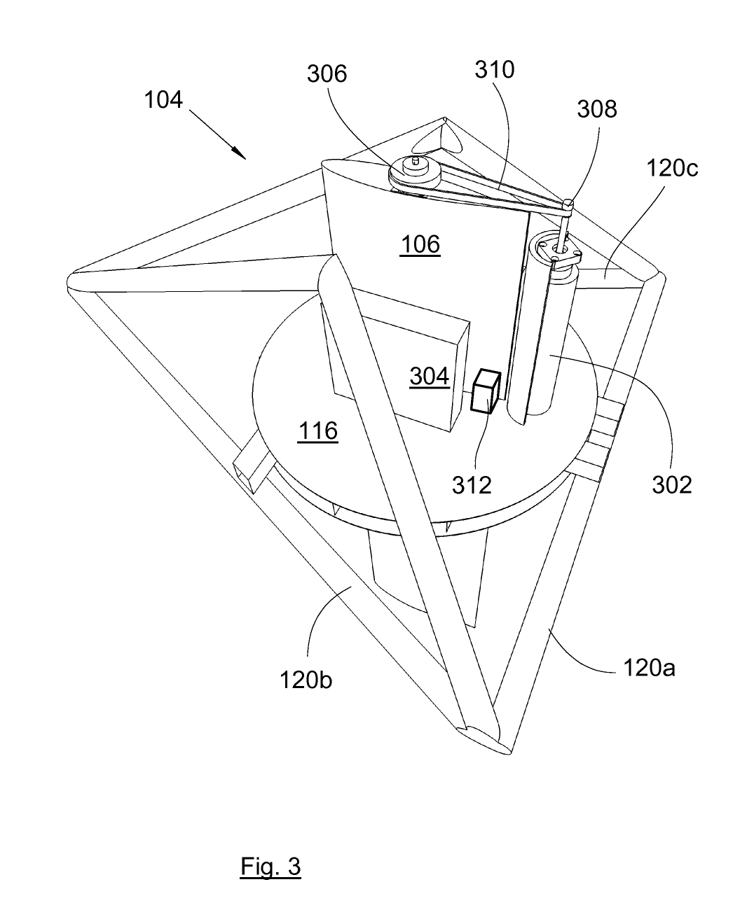

FIG. 3 shows the interior of the floating tidal turbine's technical room, and

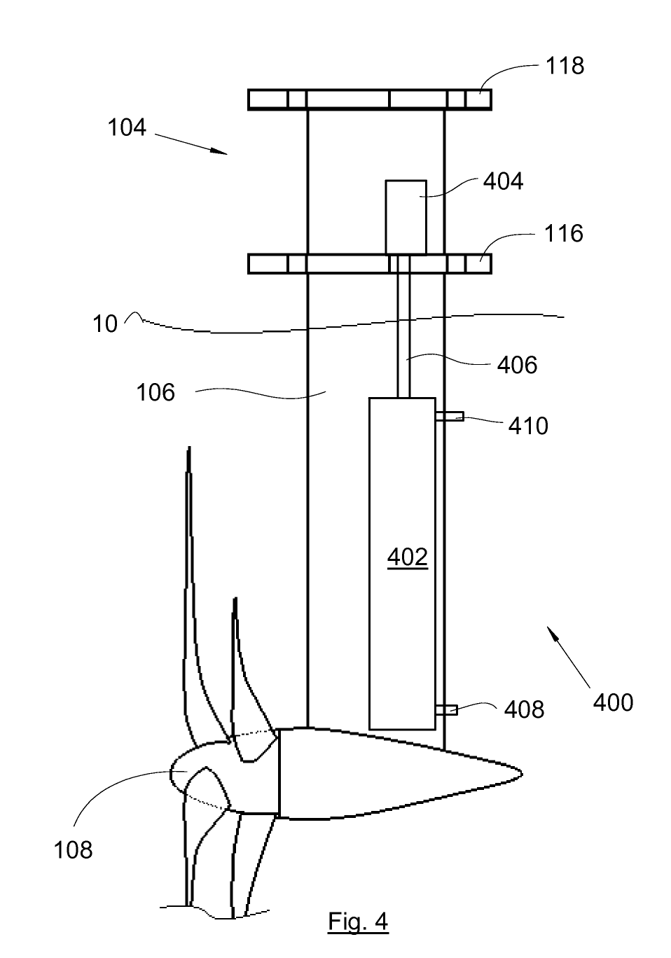

FIG. 4 shows a diagram depicting a system for manoeuvring the floating tidal turbine of FIG. 1.

In the following description that follows, the terms related to a position refer to a floating tidal turbine in its operating position, meaning as it is depicted in FIG. 1.

FIG. 1 and FIG. 2 show a floating tidal turbine 100 that comprises:
means of flotation 102,
a technical room 104 resting on the means of flotation 102 above the water (10, FIG. 4),
a mast 106 immersed in water beneath the control room 104, and
a propeller 108 mounted rotationally on the base of the mast 106 around a horizontal axis of rotation.

FIG. 3 shows the inside of the technical room 104.

The technical room 104 bears the various electrical technical components such as the electrical generator 302, electrical cabinets 304, the control panel, etc.

The floating tidal turbine 100 also comprises a manoeuvring system that is designed to raise or lower the mast 106 along an axis that is vertical relative to the technical room 104. Raising the mast 106 makes it possible to remove the propeller 108 from the water in order to perform maintenance on the propeller 108 and its means of rotation.

In the lowered position of the mast 106, the propeller 108 is in the operating position and immersed in the water. In the raised position of the mast 106, the propeller 108 is in the operating position and out of the water.

The floating tidal turbine 100 also comprises means of transfer that make it possible to transmit the rotational movement of the propeller 108 to the electrical generator 302.

Such as floating tidal turbine 100 is stable on water, and installing the electrical technical components while dry inside the technical room avoids the need to include special water-proofing means.

The mast 106 has an appropriate profile, for example one of the NACA type, which extends along a central vertical axis and whose leading edge is oriented towards the incident flux, i.e. towards the front of the floating tidal turbine 100, and whose trailing edge is oriented towards the rear of the floating tidal turbine 100.

In the embodiment of the invention shown in FIGS. 1 and 2, the means of flotation 102 feature a front float 110a, two rear floats 110b-c and a connective structure 112 intended to link the floats 110a-c to one another and support the technical room 104.

The floating tidal turbine 100 is kept inside its fixed location by a cable 114 fastened both to the front float 110a and to the sea floor.

The front float 110a is disposed at the front of the technical room 104, and the rear floats 110b-c are disposed at the rear of the technical room 104, one being on its port side and the other starboard side.

Each float 110a-c features an elongated form that is appropriate for ensuring the orientation of the floating tidal turbine 100 relative to the tidal currents.

Each float 110a-c features a pointed bow for cutting through incident waves, but with a high-volume fill to absorb the pitch.

Each float 110a-c features a large enough U-shaped profile with a pointed nose and a stern that also ends in a fine point, in order to cause minimal pitch resulting from the pressure of waves passing onto the stern.

The technical room 104 comprises a floor 116, a roof 118 and lateral walls that are not depicted for the sake of clarity in the Figs.

The connective structure 112 is here made up of an assembly of a first set of three beams 120a-c and a second set of four beams 122a-d.

Each beam 120a-c of the first assembly takes a roughly horizontal position and links the floats 110a-c two by two. The beams 120a-c of the first assembly form an isosceles triangle and the beam 120a linking the two rear floats 110b-c constitutes the triangle's base. Each of the other two beams 120b-c links the front float 110a to one of the rear floats 110b-c.

The technical room 104 rests on the beams 120a-c of the first assembly through its floor 116.

The beams 122a-d of the second assembly are fastened between the floats 110a-c and the ceiling 118 of the technical room 104. In the embodiment of the invention presented in the Figs., for each rear float 110b-c, a beam 122b-c of the second assembly is fastened between said rear float 110b-c and the ceiling 118, and for the front float 110a, two beams 122a et 122d of the second assembly are fastened between the front float 110a and the ceiling 118.

Such a structure is simple and rigid.

In the embodiment of the invention presented here, the connective structure 112 is constructed of IPN tubes and aluminium plates. The connective structure 112 may be constructed out of other materials, such as composite materials that may, for example, be milled.

The floor 116 and the ceiling 118 each feature a hole, and the mast 106 passes through both of those holes. Each hole features a profile such that the mast 106 can move freely through it vertically, and which prevents angular movements by the mast 106 around the central axis.

The fastening of the mast 106 in the ceiling 118 and the floor 116 ensures that the mast 106 is rigid enough against the action of the tidal currents.

The electrical generator 302 is installed in the technical room 104 so as to present its axis of rotation vertically.

The vertical orientation of the electrical generator's 302 axis of rotation and the horizontal orientation of the propeller's 108 axis makes it possible to ensure the stability of the floating tidal turbine 100. This is because this double orientation creates a gyroscopic system that ensures better stability.

The means of transfer are partially disposed within the mast 106 and partially outside the mast 106.

The means of transfer comprise, for example:
a toothed pulley 308 fastened to the shaft of the electrical generator 302, shown here above the ceiling 118,
a sprocket 306 placed at the peak of the mast 106 whose axis of rotation is vertical and whose diameter is greater than that of the toothed pulley 308 and which here is also above the ceiling 118,
a horizontal transmission bar connected with the propeller 108,
a vertical transmission bar connected with the sprocket 306,
two conical gears that interlock with one another, one of which is joined with the horizontal transmission bar and the other with the vertical transmission bar, and
a toothed belt 310 that links the sprocket 306 and the toothed pulley 308.

The electrical energy created by the electrical generator 302 is then either stored in batteries aboard the floating tidal turbine 100, or transferred to the ground via an electrical conductor.

To ensure optimal load distribution, the electrical generator 302 is disposed just behind the trailing edge of the mast 106.

Likewise, the technical room 104 comprises two electrical cabinets 304, one of them being disposed on the port side of the mast 106 and the other being disposed on the starboard side of the mast 106.

Additionally, the ceiling 118 and the floor 116 are circular in shape and the side walls in this case take the shape of a cylinder whose axis roughly coincides with the central axis of the mast 106 and the isosceles triangle's centre of gravity.

FIG. 4 shows a diagram of a manoeuvring system 400 that makes it possible to raise or lower the mast 106 parallel to its central axis.

The manoeuvring system 400 comprises a tank 402 disposed under the envelope of the mast 106 and on its lower part, a compressed air generator 404 disposed within the technical room 104, a conduit 406 linking the compressed air generator 404 to the tank 402.

The tank 402 also features, on its lower part, a first valve 408 linking the inside of said tank 402 with the outside, and in particular, the water, and on the upper part, a second valve 410 linking the inside of said tank 402 with the outside.

Each valve 408, 410 can be remotely controlled independently to open and to close.

The operation of the manoeuvring system 400 is then as follows, starting from the submerged position of the mast 106, when the tank 402 is filled with water and the two valves 408 and 410 are closed.

When the mast 106 must be raised again, the first valve 408 is open and the second valve 410 stays closed. The compressed air generator 404 sends air from the tank 402 through the conduit 406 so as to drive water out from the tank 402 by means of the first valve 408. The mast 106 then rises back up due to the effect of buoyant force.

When the mast 106 has reached its raised position, the first valve 408 is closed to hold the air inside the tank 402.

When the mast 106 must be lowered again, the first valve 408 and the second valve 410 are opened. The air is then driven out by the second valve 410 due to the intake of water by the first valve 408. The mast 106 then submerges into the water again.

When the mast 106 has reached its lowered position, the first valve 408 and the second valve 410 are closed.

The mast 106 is particularly guided as it moves by the holes that it passes through in the floor 116 and the ceiling 118.

To ensure that the mast 106 is optimally held in place, the tidal turbine 100 features means of locking that make it possible to lock the position of the mast 106 when the mast is in its lowered position, and potentially to lock the position of the mast 106 when it is in its raised position.

According to one embodiment of the invention, the means of locking take the shape of at least one latch 312 that passes through the mast 106 through an orifice that it features for that purpose. In the lowered position, the orifice is located at the level of the floor 116, and more particularly behind the vertical transmission bar. In this position each latch 312 thereby rests on the floor 116 and is potentially mounted on rolling bearings.

In the raised position, at the level of each latch 312, another orifice passing through the mast 106 may be provided. In the raised position, that other orifice is also at the level of the floor 116 to allow the installation of the corresponding latch 312.

Of course, it is possible to provide the installation of several tanks 402, each one featuring a first valve 408 and a second valve 410 and a conduit 406 linking it to the compressed air generator 404.

To allow the mast 106 to move, at least part of the means of transfer is removable. In the embodiment of the invention presented here, the toothed belt 310 is removed first.

For improved performance, the propeller 108 here is a contra-rotating propeller that comprises two propellers, one placed behind the other in the same axis, and turning in opposite directions.

To fully benefit from the power amplification effect, the distance between the centres of the two propellers is less than 10% of the propellers' diameter.

Of course, this invention is not limited to the examples and embodiments described and represented, but it is susceptible to numerous variants that are accessible to an expert.

For example, the means of flotation 102 may feature four floats divided into pairs to the front and rear of the technical room 104 and on the port and starboard sides of the technical room 104. In particular, the means of flotation 102 features two floats in front and two floats in the rear, the two floats in front having greater dimensions than the two floats in the rear.

The means of flotation 102 may feature two floats, one disposed on the port side of the technical room 104 and the other on the starboard side.

The means of flotation 102 may feature two floats in the front and a float in the rear.

Generally speaking, the means of flotation 102 feature at least two floats.

1-10. (canceled)

11) A floating tidal turbine comprising:
means of flotation,
a technical room resting on the means of flotation above the water and in which is disposed an electrical generator,
a mast immersed in water beneath the control room,
a propeller mounted rotationally on the base of the mast around a horizontal axis of rotation,
means of transfer that make it possible to transmit the rotational movement of the propeller to the electrical generator, and
a manoeuvring system that is designed to raise or lower the mast along a axis that is vertical relative to the technical room.

2) The floating tidal turbine according to claim 11, wherein the technical room features a floor and a ceiling and in that the floor and the ceiling each exhibit a hole that the mast passes through.

13) The floating tidal turbine according to claim 12, wherein the means of flotation comprise:
at least two floats, and
a connective structure intended to connect the floats to one another and to support the technical room.

14) The floating tidal turbine according to claim 13, wherein the connective structure comprises:
a first set of three beams, each one taking a roughly horizontal position and linking the floats two by two and on which said floor rests, and
a second set of four beams, each one being fastened between one of the floats and said ceiling.

15) The floating tidal turbine according to claim 12, wherein it comprises at least one latch, in that the mast features, for the or each latch, an orifice passing through it and into which said latch fits, and in that when the mast is in the lowered position, said orifice is at the level of the floor.

16) The floating tidal turbine according to claim 11, wherein the axis of rotation of the electrical generator is vertical.

17) The floating tidal turbine according to claim 16, wherein the electrical generator is disposed just behind the trailing edge of the mast.

18) The floating tidal turbine according to claim 11, wherein the manoeuvring system comprises a tank disposed inside the mast featuring, on its lower part, a first valve connecting the inside of said tank with the outside, and on its upper part, a second valve connecting the inside of said tank with the outside, each one able to be controlled independently to open and to close, a compressed air generator disposed in the technical room, and a conduit connecting the compressed air generator to the tank.

19) The floating tidal turbine according to claim 11, wherein the propeller is a contra-rotating propeller that comprises two propellers placed one behind the other in the axis, and rotating in opposite directions.

20) The floating tidal turbine according to claim 19, wherein the distance between the centres of the two propellers is less than 10% of the propellers' diameter.
